(19) United States
(12) Patent Application Publication
(10) Pub. No.: US 2009/0026265 A1
(43) Pub. Date: Jan. 29, 2009

(54) DETERMINING A POSITION OF A PRINT CARRIAGE

(76) Inventors: Jason C. Grosse, Vancouver, WA (US); Rick M. Tanaka, Vancouver, WA (US); Hsue-Yang Liu, Vancouver, WA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/782,765

(22) Filed: Jul. 25, 2007

(51) Int. Cl. G06K 7/00

(52) U.S. Cl. 235/435

(57) ABSTRACT

A system is provided that includes an encoder strip having encoder markings and at least a first index marking along a length of the encoder strip, an encoder configured to generate a first signal that indicates detection of the encoder markings in response to being moved along the length of the encoder strip, an index sensor configured to generate a second signal that indicates detection of the first index marking in response to being moved along the length of the encoder strip in unison with the encoder, and processing circuitry configured to determine a first encoder index value that corresponds to a center of the first index marking using the first and the second signals.

### BACKGROUND

Inkjet printing systems that include two or more print carriages align the print carriages with one another to prevent print defects from occurring when printing an image onto a print medium. In order to align the print carriages, the location of each print carriage is determined. If the location of each print carriage is not properly determined, the print carriages may be misaligned and cause print defects. It would be desirable to accurately identify the location of a print carriage.

### BRIEF DESCRIPTION OF THE DRAWINGS

FIGS. 1A-1B are block diagrams illustrating one embodiment of an inkjet printing system.

FIG. 2 is a schematic diagram illustrating one embodiment of selected portions of an inkjet printing system.

FIGS. 3A-3B are flow charts illustrating embodiments of methods for determining a position of a print carriage.

FIGS. 4A-4B are diagrams illustrating embodiments of index sensor signals.

### DETAILED DESCRIPTION

In the following detailed description, reference is made to the accompanying drawings, which form a part hereof, and in which is shown by way of illustration specific embodiments in which the disclosed subject matter may be practiced. It is to be understood that other embodiments may be utilized and structural or logical changes may be made without departing from the scope of the present disclosure. The following detailed description, therefore, is not to be taken in a limiting sense, and the scope of the present disclosure is defined by the appended claims.

According to one embodiment, an inkjet printing system determines locations of print carriages relative to respective encoder strips. An index sensor on each print carriage detects at least one index marking on the encoder strip in response to being moved along the encoder strip. A controller correlates the index marking with an encoder index that corresponds to encoder markings detected by an encoder on each print carriage. The controller determines the location of each print carriage by identifying a current encoder index value of an encoder marking that corresponds to a center of an index marking, comparing the current encoder index value to a previous encoder index value, and updating the encoder index position based on the comparison.

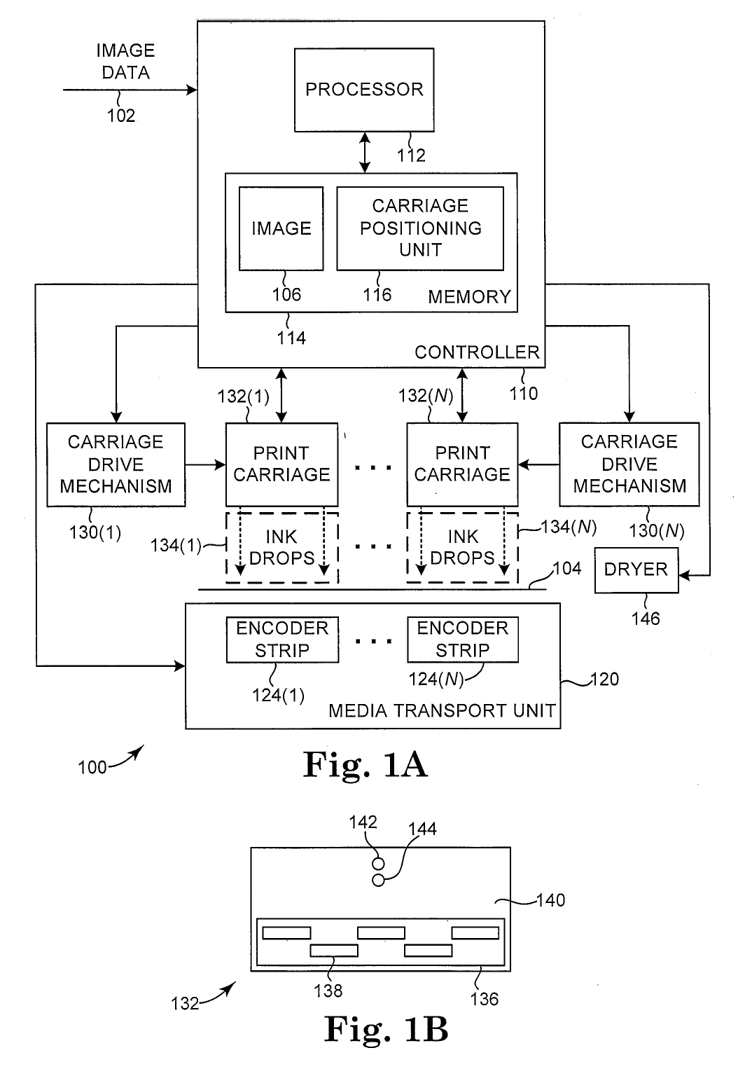

FIG. 1A is a block diagram illustrating one embodiment of an inkjet printing system 100. Inkjet printing system 100 is configured to receive image data 102 that represents an image and cause a reproduction of the image to be formed on a print medium 104 such as paper. Inkjet printing system 100 may also include other imaging units such as a scanner and/or a fax machine (not shown).

Inkjet printing system 100 receives image data 102 from any suitable image data source (not shown) such as a computer system, a mobile device, or a storage system. Inkjet printing system 100 may connect to the image data source by any suitable connection that allows image data 102 to be received by inkjet printing system 100 such as a wired or wireless point-to-point connection or a wired or wireless network connection. The network connection may connect to a local area network (LAN), a wide area network (WAN), or a global communications network such as the Internet.

A controller 110 in system 100 includes a processor 112 and a memory 114. Controller 110 receives image data 102 and stores each set of image data 102 as an image 106 in memory 114. Image 106 represents, for example, all or a portion of a document and/or a file to be printed. Controller 110 provides signals that include print data corresponding to image 106 and control signals to a media transport unit 120, two or more carriage drive mechanisms 130(1)-130(N), and two or more print carriages 132(1)-132(N) to cause image 106 to be reproduced on print medium 104. Processor 112 executes instructions stored in memory 114 to operate system 100. Memory 114 is any suitable storage medium that is accessible to processor 112 to allow processor 112 to access and store instructions and/or data. Memory 114 may include any suitable type and/or combination of volatile and non-volatile memory devices in any suitable configuration. A carriage positioning unit 116 aligns print carriages 132 with respect to one another using an index sensor 142 and an encoder 144 (shown in FIG. 1B) and an encoder strip 124 for each print carriage 132 as described in additional detail below.

To print image 106, media transport unit 120 moves print medium 104 past print carriages 132(1)-132(N) in response to signals from controller 110. As print medium 104 moves past print carriages 132(1)-132(N), controller 110 provides signals and print data to carriage drive mechanisms 130(1)-130(N) and print carriages 132(1)-132(N). Carriage drive mechanisms 130(1)-130(N) scan print carriages 132(1)-132(N), respectively, back and forth across print medium 104 and print carriages 132(1)-132(N) selectively deposit or eject ink drops 134(1)-134(N), respectively, onto print medium 104 in accordance with the print data to reproduce image 106 on print medium 104. Media transport mechanism 120 may also include a media feed mechanism (not shown) to feed print medium 104 and/or one or more media supply trays (not shown) to store additional print media 104.

Referring to FIG. 1B, each print carriage 132 includes a printhead array 136 of one or more printheads 138 mounted on, attached to, integrally formed with, or otherwise affixed to a substrate 140 in any suitable way. Each printhead 138 is configured to selectively deposit or eject drops of ink 134 onto print medium 104. The ink deposited or ejected by printheads 138 may be propelled by thermal heating, piezoelectric actuators, or another suitable mechanism. The set of printheads 138 in each printhead array 136 may deposit or eject one or more colors of ink. A dryer 146 provides heat to dry the ink on print medium 104 in response to signals from controller 110.

Each print carriage 132 also includes an index sensor 142 and an encoder 144 that are used to identify a location of each print carriage 132 with respect to a respective encoder strip 124 (shown in FIG. 1A). Each encoder strip 124 is positioned relative to media transport mechanism 120 so that a corresponding index sensor 142 and encoder 144 pass over each encoder strip 124 as a print carriage 132 moves across print medium 104 as will be described in additional detail below. Each index sensor 142 and encoder 144 are mounted on, attached to, integrally formed with, or otherwise affixed in to substrate 140 in any suitable way.

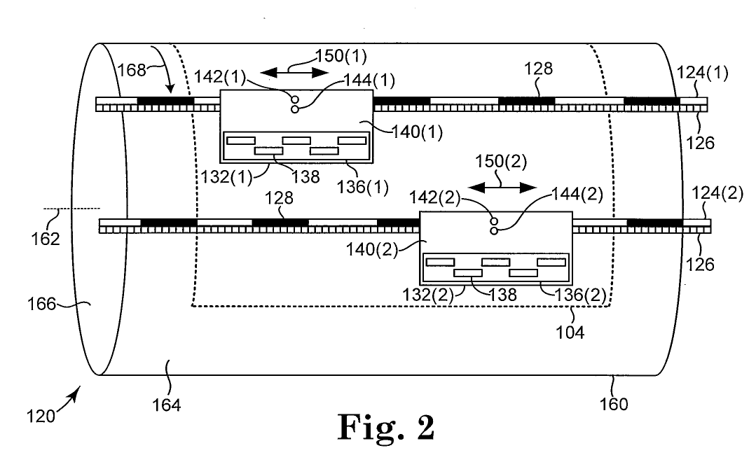

FIG. 2 is a schematic diagram illustrating one embodiment of selected portions of inkjet printing system 100 with two print carriages 132(1) and 132(2) where each print carriage 132(1) and 132(2) prints to a different portion of a page width of print medium 104.

In the embodiment of FIG. 2, media transport unit 120 includes a cylindrical drum 160. Drum 160 rotates around an axis of rotation 162 that is parallel to an outer surface 164 of drum 160 and centered with reference to side surfaces 166 of drum 160. Media transport unit 120 rotates drum 160 to move print medium 104 past printheads 138 on print carriages 132(1) and 132(2) as indicated by an arrow 168. As it rotates past print carriages 132(1) and 132(2), print medium 104 is held stationary on drum 160 by air suction or another suitable technique.

To print swaths of image 106 along the width of print medium 104, media transport unit 120 rotates drum 160 to position print medium 104 with respect to printhead arrays 136(1) and/or 136(2). Printhead arrays 136(1) and/or 136(2) deposit or eject ink onto print medium 104 as print carriages 132(1) and/or 132(2) are moved along the width of print medium 104 (i.e., parallel to axis of rotation 162) as indicated by arrows 150(1) and 150(2), respectively, while drum 160 is stationary. Each printhead array 136(1) and 136(2) prints to a different portion of a page width of print medium 104 where the page width is parallel with axis of rotation 162. After printhead arrays 136(1) and/or 136(2) complete the swath or swaths, media transport unit 120 rotates drum 160 to advance print medium 104 with respect to printhead arrays 136(1) and/or 136(2) for a next swath or swaths. Each print swath may have a width of approximately one inch, for example.

Printhead arrays 136(1) and 136(2) may form the entire image 106 on print medium 104 in one revolution of drum 160 (i.e., print medium 104 moves past printhead arrays 136(1) and 136(2) once) or multiple revolutions of drum 160 (i.e., print medium 104 moves past printhead arrays 136(1) and 136(2) more than once).

Because printhead arrays 136(1) and 136(2) print to different portions of the page width of print medium 104, inkjet printing system 100 accurately positions print carriages 132(1) and 132(2) relative to each other to prevent print defects from occurring where the print boundaries of the portions formed by printhead arrays 136(1) and 136(2) on print medium 104 intersect. If print carriages 132(1) and 132(2) are not properly aligned, defects such as a light or dark line or a visible discontinuity at the joint may occur where at the intersection of the print boundaries.

Inkjet printing system 100 tracks the location of each print carriage 132 along the width of drum 160 that is parallel to axis of rotation 162 using an encoder index that corresponds to encoder markings 126 detected by encoder 144. As index sensor 142(1) and encoder 144(1) move across drum 160 in unison as indicated by arrow 150(1), index sensor 142(1) and encoder 144(1) generate index and encoder signals, respectively, that correspond to index markings 128 and encoder markings 126 on encoder strip 124(1). Similarly, index sensor 142(2) and encoder 144(2) generate index and encoder signals, respectively, that correspond to index markings 128 and encoder markings 126 on encoder strip 124(2) as index sensor 142(2) and encoder 144(2) move across drum 160 in unison as indicated by arrow 150(2). Carriage positioning unit 116 processes the index and encoder signals from each print carriage 132 to identify a location of each print carriage 132 relative to a respective encoder strip 124 as will be described in additional detail below.

The length of each encoder strip 124 spans the width of drum 160 parallel to axis of rotation 162 and has a first portion along the length with encoder markings 126 at set intervals along the width and a second portion along the length with index markings 128 along the width. The first and second portions of each encoder strip 124 may be adjacent as shown in the embodiment of FIG. 2 or in another fixed relation to one another in other embodiments.

In one embodiment, each encoder strip 124 is made out of a transparent material such as Mylar or polyester film with encoder markings 126 and index markings 128 that are dark or opaque regions to form a sharp visible contrast with the transparent material. In other embodiments, encoder strips 124 may be formed with other materials with other suitable encoder markings 126 and index markings 128.

In one embodiment, encoder markings 126 are spaced at 1/200 inch intervals along the length of encoder strip 124 and five index markings 128 are spaced at set intervals along the length of encoder strip 124. In other embodiments, encoder markings 126 may be spaced at other intervals along the length of encoder strip 124 and other numbers of index markings 128 may be included on encoder strip 124.

Each index marking 128 has a sufficient width relative to encoder markings 126 to allow-controller 110 to identify an encoder markings 126 that corresponds to a center or a nearest to center of each index marking 128 along the length of encoder strip 124. Accordingly, each index marking 128 is significantly wider than each encoder marking 126 and each encoder strip 124 includes significantly more encoder markings 126 than index markings 128.

Substrate 140 may be formed of either a relatively invariant material such as Invar or a material with well known expansion coefficient. Substrate 140 is positioned with sufficient proximity to encoder strip 124 to allow index sensor 142 and encoder 144 to detect index markings 128 and encoder markings 126, respectively, as index sensor 142 and encoder 144 are moved along encoder strip 124.

Index sensor 142 optically scans index markings 128 on encoder strip 124 to generate one or more analog electrical signals that indicate the presence or absence of index markings 128 as index sensor 142 is moved in along encoder strip 124. Index sensor 142 may include an opto interruptor or other suitable sensor configured to generate a signal in response to index markings 128 on encoder strip 124. Index sensor 142 provides the signal or signals to controller 110. In one embodiment, index sensor 142 is directly coupled to a general purpose input/output (GPIO) port of processor 112 and provides at least one signal as a digital input to a GPIO port of processor 112. In other embodiments, index sensor 142 provides the signal or signals directly or indirectly to controller 110 in other suitable ways.

Encoder 144 optically scans encoder markings 126 on encoder strip 124 to generate one or more analog electrical signals that indicate the presence or absence of encoder markings 126 as encoder 144 is moved in along encoder strip 124. In one embodiment, encoder 144 generates four signals—a channel A signal, a channel B signal, an inverted channel A signal, and an inverted channel B signal. In other embodiments, encoder 144 generates another signal or signals. Encoder 144 provides the signal or signals to controller 110. In one embodiment, encoder 144 is directly coupled to a general purpose input/output (GPIO) port of processor 112 and provides at least one signal as a digital input to a GPIO port of processor 112. In other embodiments, encoder 144 provides the signal or signals directly or indirectly to controller 110 in other suitable ways.

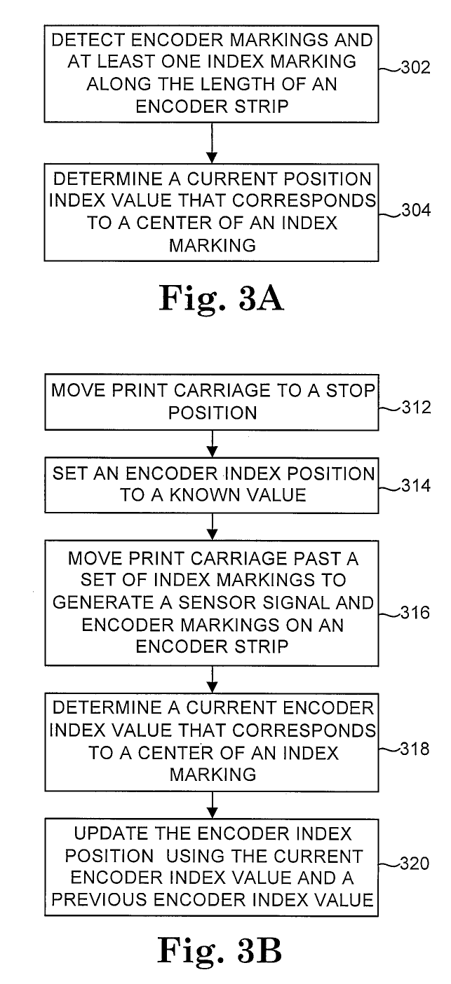

Inkjet printing system 100 determines the location of each print carriage 132 with reference to a respective encoder strip 124 using index sensor 142 and encoder 144. For each print carriage 132, inkjet printing system 100 determines a current encoder index value that corresponds to a center of an index marking 128. Inkjet printing system 100 compares the current encoder index value with a previous encoder index value that previously corresponded to the center of an index marking 128 and, from the comparison, adjusts the encoder index position of the print carriage 132 to locate the print carriage 132 relative to encoder strip 124. FIGS. 3A-3B are flow charts illustrating embodiments of methods for determining positions of print carriages 132. Inkjet printing system 100 determines the location of each print carriage 132 in response to being turned on (i.e., powered up) or reset or in response to other suitable events.

One embodiment of the operation of determining the location of a print carriage 132 will now be described with reference to FIG. 3A. The method of FIG. 3A will be described as being performed by carriage positioning unit 116. In other embodiments, other components of controller 110 may perform all or portions of the method of FIG. 3A. Carriage positioning unit 116 performs the method of FIG. 3A independently for each print carriage 132(1)-132(N) with respective encoder strip 124(1)-124(N) in one embodiment.

In FIG. 3A, carriage positioning unit 116 detects encoder markings 126 and at least one index marking 128 along the length of an encoder strip 124 as indicated in a block 302. As print carriage 132 is moved along encoder strip 124, encoder 144 generates an encoder signal that indicates detection of encoder markings 126 and index sensor 142 generates an index sensor signal that indicates detection of at least one index marking 128. Carriage positioning unit 116 receives and processes the encoder signal and the index sensor signal to correlate the index sensor signal with an encoder index that corresponds to encoder markings 126 detected by encoder 144.

Carriage positioning unit 116 determines a current encoder index value that corresponds to a center of the index marking 128 as indicated in a block 304. Carriage positioning unit 116 analyzes the index sensor signal to identify a waveform in the index sensor signal that corresponds to the index marking 128. Carriage positioning unit 116 determines a centroid of the waveform and identifies the current encoder index value that corresponds to the centroid. Carriage positioning unit 116 determines a location of a print carriage 132 by comparing the current encoder index value to a previously determined encoder index value that previously corresponded to the center of the index marking 128 and updating the encoder index position relative to the center of the index marking 128 to locate print carriage 132 relative to encoder strip 124.

Another embodiment of the operation of determining the location of a print carriage 132 will now be described with reference to FIG. 3B. The method of FIG. 3B will be described as being performed by carriage positioning unit 116. In other embodiments, other components of controller 110 may perform all or portions of the method of FIG. 3B. Carriage positioning unit 116 performs the method of FIG. 3B independently for each print carriage 132(1)-132(N) with respective encoder strip 124(1)-124(N) in one embodiment.

In FIG. 3B, carriage positioning unit 116 moves print carriage 132 to a stop position as indicated in a block 312. The stop position may be a hard stop position where print carriage 132 impacts a housing or other structure of inkjet printing system 100 (not shown) or another suitable location along the length of encoder strip 124. Carriage positioning unit 116 moves print carriage 132 to a hard stop position near an end of the length of encoder strip 124 in one embodiment.

Carriage positioning unit 116 set the encoder index position to a known value as indicated in a block 314. Subsequent to moving print carriage 132 to the stop position, carriage positioning unit 116 sets the encoder index position to a known value such as zero, a maximum value, or another value that approximates a location of the stop.

Carriage positioning unit 116 causes print carriage 132 to move past a set of one or more index markings 128 and a series of encoder markings 126 on encoder strip 124 as indicated in a block 316. As print carriage 132 moves along encoder strip 124, carriage positioning unit 116 may increment or decrement the encoder index position for each encoder marking 126 detected by encoder 144 to track the location of print carriage 132 relative to encoder strip 124. Carriage positioning unit 116 stores the index sensor signal from index sensor 142 that indicates detection of the set of index markings 128 relative to the encoder index that corresponds to encoder markings 126 detected by encoder 144.

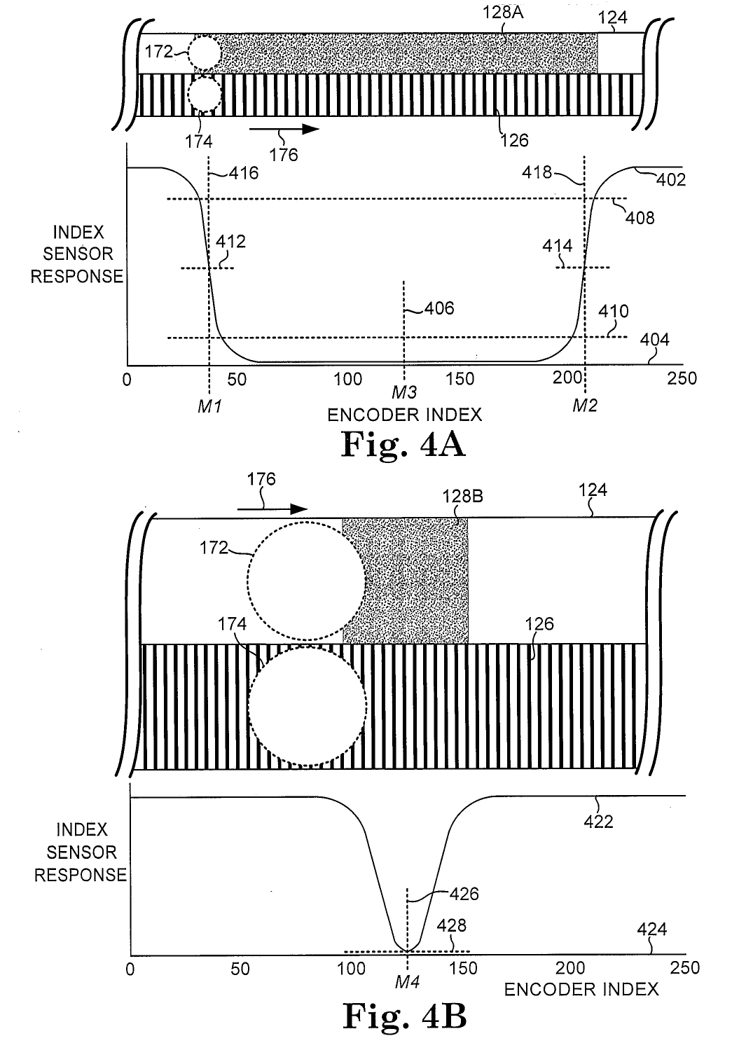

Carriage positioning unit 116 determines a current encoder index value that corresponds to a center of an index marking 128 as indicated in a block 318. Such a determination will now be described with reference to examples shown in FIGS. 4A and 4B.

FIG. 4A is a diagram illustrating one example of an index sensor signal 402 that corresponds to an index marking 128A. As print carriage 132 moves along encoder strip 124 in the direction indicated by an arrow 176, a field of view 172 of index sensor 142 passes over index marking 128A to cause index sensor 142 to generate index sensor signal 402. In signal 402, the signal transitions (i.e., the signal changes from a high to a low signal level and from a low to a high signal level) each indicate an edge of index marking 128A, and therefore a location, of index marking 128A. One signal level of signal 402 (i.e., a low signal level in the example of FIG. 4A) indicates the presence of index marking 128A and the other signal level of signal 402 (i.e., a high signal level in the example of FIG. 4A) indicates the absence of index marking 128A. A field of view 174 of encoder 144 passes over encoder markings 126 to cause encoder 144 to generate an encoder signal (not shown) as print carriage 132 moves along encoder strip 124. Carriage positioning unit 116 determines an encoder index 404 from the encoder signal and processes index sensor signal 402 from index sensor 142 relative to encoder index 404 as shown in FIG. 4A.

To determine a current encoder index value that corresponds to a center of index marking 128A, carriage positioning unit 116 determines a centroid 406 of the waveform of signal 402 that corresponds to index marking 128A. In one embodiment, carriage positioning unit 116 determines an upper bound 408 and a lower bound 410 of the waveform. From the upper and lower bounds 408 and 410, carriage positioning unit 116 determines midpoints 412 and 414 on the falling and rising edges of the waveform, respectively, and determines encoder index values M1 and M2 that correspond to intersections 416 and 418 of midpoints 412 and 414 along encoder index axis 404. Carriage positioning unit 116 determines a current encoder index value M3 at centroid 406 by averaging or otherwise combining the encoder index values M1 and M2. Because centroid 406 corresponds to the center of index marking 128A, the current encoder index value M3 also corresponds to the center of index marking 128A. In other embodiments, carriage positioning unit 116 processes signal 402 to determine a current encoder index value from centroid 406 in other ways.

FIG. 4B is a diagram illustrating another example of an index sensor signal 422 that corresponds to an index marking 128B that is narrower that index marking 128A in FIG. 4A. As print carriage 132 moves along encoder strip 124 in the direction indicated by arrow 176, the field of view 172 of index sensor 142 passes over index marking 128B to cause index sensor 142 to generate index sensor signal 422. In signal 422, the signal transitions (i.e., the signal changes from a high to a low signal level and from a low to a high signal level) each indicate an edge of index marking 128B, and therefore a location, of index marking 128B. One signal level of signal 422 (i.e., a low signal level in the example of FIG. 4B) indicates the presence of index marking 128B and the other signal level of signal 422 (i.e., a high signal level in the example of FIG. 4B) indicates the absence of index marking 128B. A field of view 174 of encoder 144 passes over encoder markings 126 to cause encoder 144 to generate an encoder signal (not shown) as print carriage 132 moves along encoder strip 124. Carriage positioning unit 116 determines an encoder index 424 from the encoder signal and processes index sensor signal 422 from index sensor 142 relative to the encoder index as shown in FIG. 4B.

To determine a current encoder index value that corresponds to a center of index marking 128B, carriage positioning unit 116 determines a centroid 426 of the waveform of signal 422 that corresponds to index marking 128B. Carriage positioning unit 116 may interpolate extremum 428 of the waveform of signal 422 or fit the waveform of signal 422 to a curve function, such as a normal distribution curve, to determine centroid 426. In FIG. 4B, carriage positioning unit 116 determines an encoder index value M4 at centroid 426 that corresponds to the intersection of centroid 426 on encoder index 424. Because centroid 426 corresponds to the center of index marking 128B, the encoder index value M4 also corresponds the center of index marking 128B.

In embodiments where encoder strip 124 includes more than one index marking 128, such as in the embodiment of FIG. 2, carriage positioning unit 116 may determine an encoder index value that corresponds to a center of each index marking 128 from the centroid of corresponding waveforms as just described. Carriage positioning unit 116 may average or otherwise combine the encoder index values to determine an encoder index value of the center of the centermost index marking 128 of encoder strip 124. By determining the encoder index value of the center of the centermost index marking 128 from multiple encoder index values, carriage positioning unit 116 may minimize the effect of noise on index sensor signal 402 or 422.

Carriage positioning unit 116 updates the encoder index position of print carriage 132 relative to the center of index marking 128 using the current encoder index value and a previous encoder index value as indicated in a block 320. Carriage positioning unit 116 accesses a previous encoder index value that corresponded to the center of index marking 128. Carriage positioning unit 116 may determine the previous encoder index value using the method of FIG. 3A or 3B at any time prior to determining the current encoder index value. For example, carriage positioning unit 116 may determine the previous encoder marking as part of a calibration process or as part of the initial process of aligning or servicing print carriages 132(1) and 132(2).

Carriage positioning unit 116 determines a difference between the current encoder index value and the previous encoder index value and updates the encoder index position of print carriage 132 by adding the difference to or subtracting the difference from the encoder index position. Once updated, the encoder index position identifies the location of print carriage 132 relative to encoder strip 124. Subsequent to updating the encoder index position, carriage positioning unit 116 tracks the location of print carriage 132 using encoder 144 as print carriage 132 is moved along encoder strip 124 (e.g., by incrementing or decrementing the encoder index position for each detected encoder marking 126).

The above embodiments may provide advantages over other techniques for determining locations of print carriages. For example, the above embodiments may reduce the effect of any noise in the samples by using a large number of measurement samples to significantly attenuate the noise from external noise sources such as mechanical vibrations caused by the measurement.

Although specific embodiments have been illustrated and described herein for purposes of description of the embodiments, it will be appreciated by those of ordinary skill in the art that a wide variety of alternate and/or equivalent implementations may be substituted for the specific embodiments shown and described without departing from the scope of the present disclosure. Those with skill in the art will readily appreciate that the present disclosure may be implemented in a very wide variety of embodiments. This application is intended to cover any adaptations or variations of the disclosed embodiments discussed herein. Therefore, it is manifestly intended that the scope of the present disclosure be limited by the claims and the equivalents thereof.

What is claimed is:

1. A system comprising:
an encoder strip having encoder markings and at least a first index marking along a length of the encoder strip;
an encoder configured to generate a first signal that indicates detection of the encoder markings in response to being moved along the length of the encoder strip;
an index sensor configured to generate a second signal that indicates detection of the first index marking in response to being moved along the length of the encoder strip in unison with the encoder; and
processing circuitry configured to determine a first encoder index value that corresponds to a center of the first index marking using the first and the second signals.

2. The system of claim 1 wherein the processing circuitry is configured to determine a position of the encoder and the index sensor relative to the encoder strip from the first encoder index value, a second encoder index value that previously corresponded to the center of the first index marking, and an encoder index position.

3. The system of claim 1 wherein the processing circuitry is configured to determine a centroid of a waveform from the second signal that corresponds to the first index marking, and wherein the first encoder index value corresponds to the centroid.

4. The system of claim 3 wherein the processing circuitry is configured to determine first and second midpoints of first and second transitions of the waveform, respectively, and wherein the processing circuitry is configured to determine the centroid from the first and the second midpoints.

5. The system of claim 3 wherein the processing circuitry is configured to determine the centroid by one of determining an extremum and fitting the waveform to a curve function.

6. The system of claim 1 wherein the encoder strip includes at least second and third index markings, wherein the second signal indicates detection of the second and the third index markings, and wherein the processing circuitry is configured to determine second and third encoder index values that correspond to centers of the second and the third index markings, respectively, using the first and the second signals.

7. The system of claim 5 wherein the processing circuitry is configured to determine a fourth encoder index value by averaging the first, the second, and the third encoder index values.

8. The system of claim 1 further comprising:
a substrate including the encoder, the index sensor, and a plurality of printheads.

9. The system of claim 8 further comprising:
a media transport mechanism configured to move a print medium past the printheads;
wherein the encoder strip is positioned relative to the media transport mechanism.

10. The system of claim 9 where the media transport mechanism includes a drum configured to rotate the print medium past the printheads.

11. A method comprising:
detecting encoder markings with an encoder as the encoder moves along an encoder strip;
detecting at least a first index marking with an index sensor as the index sensor moves in unison with the encoder along the encoder strip; and
determining a first encoder index value that corresponds to a center of the first index marking.

12. The method of claim 11 further comprising:
moving the encoder and the index sensor to a stop prior to detecting the encoder markings and detecting the at least one index marking.

13. The method of claim 12 further comprising:
setting an encoder index position that corresponds to a location of the encoder and the index sensor relative to the encoder strip to an initial value at the stop;
updating the encoder index position using the first encoder index value and a second encoder index value that previously corresponded to the center of the first index marking.

14. The method of claim 11 further comprising:
detecting at least second and third index markings with the index sensor as the index sensor moves in unison with the encoder along the encoder strip; and
determining the first encoder index value using second and third encoder index values that correspond to centers of the second and the third index markings, respectively.

15. The method of claim 11 further comprising:
updating an encoder index position using the first encoder index value and a second encoder index value that previously corresponded to the center of the first index marking.

16. A system comprising:
first means for detecting encoder markings on an encoder strip responsive to being moved along the encoder strip;
second means for detecting at least a first index marking on the encoder strip responsive to being moved along the encoder strip in unison with the first means; and
third means for determining a location of the first and the second means relative to the encoder strip using a first encoder index value that corresponds to a center of the first index marking and a second encoder index value that previously corresponded to the center of the first index marking.

17. The system of claim 16 wherein the third means is for updating an encoder index position in response to comparing the first encoder index value with the second encoder index value.

18. The system of claim 16 wherein the second means is for generating a signal with a waveform that indicates detection of first index marking, and wherein the third means is for determining a centroid of the waveform to determine the first one of the encoder markings.

19. The system of claim 16 further comprising:
a substrate including the first means, the second means, and a plurality of printheads

20. The system of claim 16 wherein the second means is for detecting at least second and third index markings on the encoder strip responsive to being moved along the encoder strip in unison with the first means, and wherein the third means is for determining second and third encoder index values that correspond to centers of the second and the third index markings, respectively.
